(19) United States
(12) Patent Application Publication
(10) Pub. No.: US 2008/0119201 A1
(43) Pub. Date: May 22, 2008

(54) SYSTEM AND METHOD FOR MATCHING USERS OF MOBILE COMMUNICATION DEVICES

(76) Inventors: Jonathan Kolber, Denver, CO (US); Mezari Myca, Denver, CO (US)

Correspondence Address: ADVANTIA LAW GROUP, 9035 SOUTH 1300 EAST, SUITE 200, SANDY, UT, 84094, US

(21) Appl. No.: 11/944,265

(22) Filed: Nov. 21, 2007

Related U.S. Application Data
(60) Provisional application No. 60/867,025, filed on Nov. 22, 2006.

(51) Int. Cl. H04Q 7/20

(52) U.S. Cl. 455/456.1

(57) ABSTRACT

A system and method for matching Mobile Communication Device (MDC) users, comprising users of mobile communication devices, comprising: a control module; a first and second MCD in communication with the control module; first and second profile module, associated with the first and second MCD, respectively; a tracking module; and an event module. The method comprises: comparing a first user profile to a second user profile; communicating the first user profile to the second MCD upon satisfaction of a first condition; and displaying and guiding the first MCD to the location of the second MCD. The method further includes: matching an event to the first and second user profile; and selecting an event characteristic from the group consisting of: event location, event activity, and event time; or any combination thereof.

### CROSS-REFERENCE TO RELATED APPLICATIONS

This invention claims priority, under 35 U.S.C. § 120, to the U.S. Provisional Patent Application No. 60867025 filed on Nov. 22, 2006, which is incorporated by reference herein.

### BACKGROUND OF THE INVENTION

1. Field of the Invention

The present invention relates to methods and systems for communication between mobile communication devices, specifically for matching users of mobile communication devices according to events, location, and attributes.

2. Description of the Related Art

In the related art, Mobile Communication Devices (MCDs) such as cell phones, Personal Digital Assistants (PDAs), laptop computers, and so forth, are often used by persons to communicate and stay in contact with other MCD users. With C advances in MCD technology, MCDs are now used not only for communicating but for downloading audio/video data, surfing the internet, listening to music, text messaging, sending and receiving email, and so forth.

Another use often applicable to MCDs is coordinating social, business, social, romantic and other types of gatherings and meetings. In some cases, MCDs may be used to seek out potential social, business, and romantic gatherings. Generally speaking however, the only method for an MCD to seek out these potential contacts is through internet and phone chat rooms. These can be time consuming, expensive, and not really informative. Typically, the current matching systems match up a plurality of users with common attributes. However, these traditional matching systems are often inadequate because they are often unable to match users who are in close proximity to one another. Additionally, the traditionally matching systems lack the capability of determining real-time positions of matched users.

Of course, the approximate location of an MCD is always known to the mobile communication infrastructure in the form of which station or tower the MCD is transmitting through (e.g., as taught in U.S. Pat. No. 6,061,561 (Alanara et al.)). A prime motivation for being able to access such information is to determine the location of MCD users who place calls to Emergency-911 call centers or are otherwise in distress. In order to improve the effectiveness of Emergency-911 services in particular, more accurate position information is being made available via the telecommunication infrastructure. For example, U.S. Pat. No. 6,067,045 (Castelloe et al.) teaches the use of combining Global Positioning System (GPS) information with a mobile communication infrastructure to accurately determine the position of an MCD, whereas U.S. Pat. No. 6,055,434 (Seraj) teaches the use of low powered beacons scattered throughout MCD usage areas. Regardless of the technology used, the end result is that telecommunication systems are rapidly being provided with an ability to accurately determine the geographic location of an individual MCD.

Applying recent technological advances in global positioning and other locating technologies to matching MCD users presents an ideal solution to the inadequacies of the traditional matching systems. However, the current matching systems and methods involving global positioning and locating technologies are inadequate. The current systems inadequately assist MCD users in locating other matched MCD users, merely providing GPS or other location coordinates. Further, the current systems fail to provide and suggest event meeting places, activities, times and so forth.

Some improvements have been made in the field. Examples of these improvements include, but are not limited to, the references described below which are incorporated by reference herein:

U.S. Pat. No. 6,618,593, issued to Drutman et al., discloses a system and method for matching first and second mobile communications devices are provided. Preference or profile information associated with the first and second mobile communications devices is transmitted to a central server for matching the first and second devices. Location information and transmission statuses of the first and second mobile communications device are also transmitted to the central server. Data related to the location of either device is transmitted to the other device depending upon the matched statuses of the mobile communications devices and the location and transmission status information associated with the mobile communications devices.

U.S. Pat. No. 6,542,749, issued to Drutman et al., discloses a method and system for connecting proximately located telecommunications units are disclosed. The method and system may be used in a location aware telecommunications system that can determine the location of a telecommunications unit (TU) being used within the system. A user may be connected to one or more other users when they have compatible attributes and when they are located within a predetermined distance of each other. The connection may be established between TUs of two or more users, based on attribute and distance information maintained by a server computer, upon the request of an initiating user's TU.

U.S. Pat. No. 6,819,919, issued to Tanaka, discloses a system enabling mobile wireless users to obtain information on other proximate users both fixed and wireless. Said information is gathered from a central database that stores user profiles and real-time locations of system users. Mobile users can request information on nearby users by submitting a request from a mobile telephone or similar communications endpoint to the central database. The request is accompanied by the user's location, obtained from GPS (Global Positioning System) or other technology, or from user input. The server searches the profile database for nearby users based on requester's location, locations of other users of the system and optional parameters specified in the request. Search results are returned to the requester. The system facilitates communication between requester and owner(s) of profiles returned by system.

U.S. Pat. No. 6,539,232, issued to Tanaka, discloses a method and system for selectively connecting proximately located telecommunications units are disclosed. The method and system may be used in a location aware telecommunications system that can determine the location of a telecommunications unit (TU) being used within the system. A first TU may be connected to a second TU when the first and second TUs are within a predetermined distance of each other and when a first user associated with the first TU may be connected to a second user associated with the second TU on a graph representing individual relationships, such as an acquaintance graph or genealogical tree. The connection may further be based on whether the first and second users have a less than a maximum threshold degree of separation within the relationship graph.

U.S. Patent Application Publication No.: 2005/0021,666, by Dinnage et al., discloses a system for matching users with profile data of interest to that user is provided to establish real-time interactive communication with another user related to the matched profile data. The system includes a matching database system that allows for entering profile data, a matching a user's profile to other profiles, and sending notification messages to a user to indicate matches made. The matching database system also has stored therein a plurality of profiles containing profile data. The system further allows users to communicate with the matching database system to enter profiles containing profile data and to receive the notification messages. The notification messages sent by the matching database system further allow the user receiving a notification message to communicate interactively in real-time with a representative of a matched profile.

The inventions heretofore known suffer from a number of disadvantages which include: providing inadequate information about potential users, inadequate matching of user profiles and/or attributes, inadequate matching of user profiles to events and/or locations, providing inadequate assistance in determining locations of users, and/or so forth.

What is needed is a system and method for matching users of MCDs that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available MCD systems. Accordingly, the present invention has been developed to provide a system and method for matching users of MCDs that enables users a quick and effective way of locating, meeting, and becoming acquainted.

In one embodiment, there is a system for matching users of MCDs comprising: a control module; a first MCD in communication with the control module; a second MCD in selective communication with the first MCD, and in communication with the control module; a first profile module associated with the first MCD and in communication with the control module; a second profile module associated with the second MCD and in communication with the control module; a tracking module in communication with the control module, and/or including instructions for tracking the location of the first MCD and/or the second MCD; and/or an event module in communication with the control module. The event module may include instructions for performing the steps of: matching an event to the first profile module and/or the second profile module; and/or selecting an event characteristic selected from the group consisting of: event location, event activity, and/or event time, and/or any combinations thereof. The event module may further include instructions for prompting a user to select the event.

In another embodiment, the system for matching users of MCDs may include a graphical user interface display module. Additionally, the first profile module and/or the second profile module may further comprise an audio and/or video module, which may be configured to enable audio and/or video profiles. The system for matching users of MCDs may further provide the first MCD with selective access to the second profile module. The selective access may comprise an audio and/or video profile associated with the second profile module. Further, the audio and/or video profile may be displayed on the graphical user interface display module.

In yet another embodiment, the system for matching users of MCDs may include a tracking module. The tracking module may include instructions for locating the first MCD and/or the second MCD. Additionally, the tracking module may comprise a global positioning module.

In still another embodiment, there is a method for matching users of MCDs. The method may comprise: providing a control module; communicating a first MCD device with a second MCD; creating a first user profile associated with the first MCD, and/or in communication with the control module; creating a second user profile associated with the second MCD, and/or in communication with the control module; tracking a location of each of the first MCD and/or the second MCD; and/or matching a first user profile with a second user profile. The matching may include: comparing a first record associated with the first user profile to a second record associated with the second user profile; communicating the first record to the second MCD upon satisfaction of a first condition; displaying the location of the second MCD on the first MCD upon satisfaction of a second condition; and/or guiding the first MCD to the location of the second MCD upon satisfaction of the second condition. Guiding the first MCD to the location of the second MCD may further comprise audio and/or video assistance.

In yet another embodiment, the method for matching users of MCDs may include: matching an event to the first user profile and/or a second user profile; and/or selecting an event characteristic from the group consisting of: event location, event activity, and/or event time, and/or any combination thereof. Additionally, the method may further include prompting a user to select the event characteristic and/or displaying the event on a graphical user interface display module.

In another embodiment, the method for matching users of MCDs may include creating a first and/or second user profile. Creating the first user profile may comprise creating a first audio and/or video profile. Additionally, the second MCD may be selectively provided access to the first audio and/or video user profile. The first audio and/or video profile may be displayed on a graphical user interface display module.

In still another embodiment, there is an article of manufacture comprising a program storage medium readable by a processor and/or embodying one or more instructions executable by the processor to perform a method for matching users of MCDs. The method may comprise the steps of: providing a control module; communicating a first MCD with a second MCD, each of the first MCD and/or the second MCD in communication with the control module; creating a first user profile associated with the first MCD, and/or in communication with the control module; creating a second user profile associated with the second MCD, and/or in communication with the control module; tracking the location of each of the first MCD and/or the second MCD; matching a first user profile with a second user profile. The matching may include: comparing a first record associated with the first user profile to a second record associated with the second user profile; communicating the first record to the second MCD upon satisfaction of a first condition; displaying the location of the second MCD upon satisfaction of a second condition; and/or guiding the first MCD to the location of the second MCD device upon satisfaction of the second condition.

In yet another embodiment, the article of manufacture may further include the steps of: matching an event to the first user profile and/or the second user profile; and/or selecting an event characteristic from the group consisting of: event location, event activity, and/or event time, and/or any combination thereof.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a relational module diagram of a system for matching users of mobile MCDs, according to one embodiment of the invention;

FIG. 2 is module diagram of a control module for matching users of mobile MCDs, according to one embodiment of the invention;

FIG. 3 is block diagram of a method for matching users of MCDs, according to one embodiment of the invention;

FIG. 4 is block diagram of a method for matching users of MCDs, according to one embodiment of the invention; and

FIG. 5 is block diagram of a method for matching users of MCDs, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Further, many of the functional units and/or modules are “matched”, are being “matched”, and/or are “matching” with other functional units and/or modules. “Matching” and/or being “matched” refers to comparing the data and/or metadata associated with one functional unit and/or module with the data and/or metadata of another functional unit and/or module, and further locating two or more functional units and/or modules with defined similarities in data and/or metadata. In one non-limiting example, location data associated with a first MCD user is matched and/or compared with that of a second MCD user. If both MCD users are within a defined radius of each other, the radius being defined by each MCD user and/or a central control module, then the first and second MCD user are “matched”. In another non-limiting example, attribute and/or personal interest data associated with a first MCD user and a second MCD user are compared. If the data contains defined similarities the first and second MCD users are “matched.”

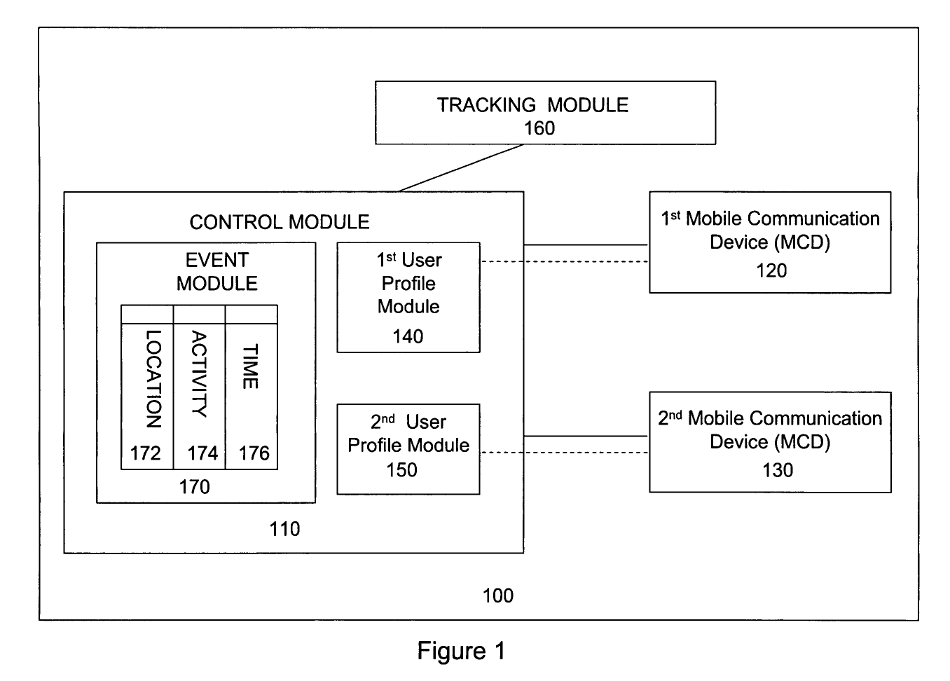

As shown in FIG. 1, there is a system 100 for matching users of mobile communication devices (MCD), comprising: a control module 110; a first MCD 120 in communication with the control module 110; a second MCD 130 in selective communication with the first MCD 120, and in communication with the control module 110; a first user profile module 140 associated with the first MCD 120 and in communication with the control module 110; a second user profile module 150 associated with the second MCD 130 and in communication with the control module 110; a tracking module 160 in communication with the control module 110, and including instructions for tracking the location of the first MCD 120 and the second MCD 130; and an event module 170 in communication with the control module 110. The event module 170 includes instructions for performing the steps of: matching an event to the first user profile module 140 and the second user profile module 150; and selecting an event characteristic selected from the group consisting of: event location 172, event activity 174, and event time 176.

Also shown in FIG. 1, the system 100 for matching includes a first MCD 120 and a second MCD 130. The first MCD 120 is in communication with the control module 110 and may selectively be in communication with the second MCD 130. Similarly, the second MCD 130 is also in communication with the control module 110 and may be selectively in communication with the first MCD 120. In selectively being in communication with each other, communication between the first MCD 120 and the second MCD is controlled and/or limited by the control module 110, the first MCD 120, and/or the second MCD 130 (described in more detail below). The first MCD 120 and second MCD 130 may be any type of MCD contemplated in the art. Some non-limiting examples include: cell phones, smart phones, Personal Digital Assistants (PDA), laptop and/or handheld computers, pagers, wireless web browsers and/or so forth; indeed, any transmitter, transceiver, and/or receiver capable of supporting a connection. In another embodiment, the system 100 includes a plurality of MCDs 120, 130 all in communication with the control module 110 and selectively in communication with other MCDs registered with the control module 110.

Additionally, shown in FIG. 1, the system 100 for matching includes a control module 110. The control module 110 functions and/or includes instructions for administering, controlling, and managing communications between the first MCD 120 and the second MCD 130; indeed the communications between a plurality of MCDs in the system. The control module 110 may exist in any form contemplated in the art. In one non-limiting example, the control module 110 includes centralized server module and a processor module. The control module 110 may further include: a storage module 210, configured to store data; a database module 240; a graphic user interface module 230; and an event module 170. The control module 110 may additionally include a plurality of user profile modules 140, 150.

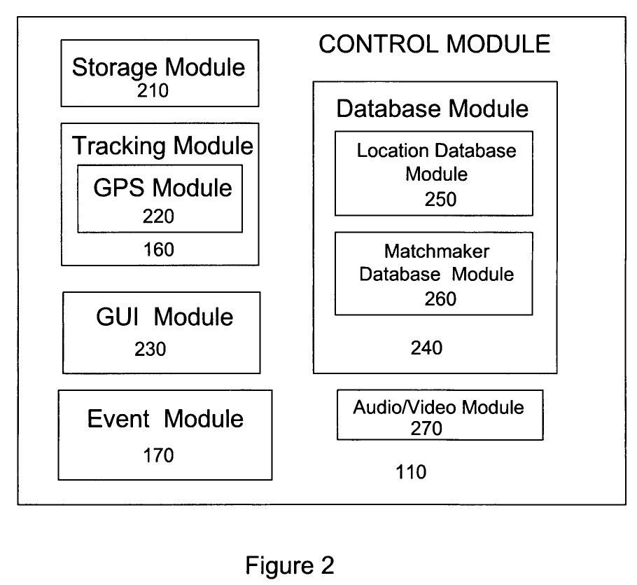

Illustrated in FIG. 2, the illustrated control module 110 includes a storage module 210. The storage module 210 is configured to store data such as, but not limited to, data associated with user profile modules 140, 150, user registration, and/or other data. The storage module 210 may be any type of storage module contemplated in the art, such as, but not limited to: one or more servers, hard drives, memory, random access memory, processors, and/or so forth. Such storage modules are commonly known among those persons skilled in the art. One example of such storage module may include the ANTs Data Server 3.61 available through ANTs Software, inc. of Burlingame, Calif. 094010.

Shown in FIG. 2, the control module 110 includes a database module 240. The database module 240 is configured to sort, manage, control, and/or otherwise administer the user profile modules 140, 150 and/or other data in the storage module 210. The database module 240 includes algorithms and other methods for matching the first MCD 120 with the second MCD 130. The database module 240 may further include a location database module 250, and a match maker database module 260. The database module 250 may be any type and/or kind of database module contemplated in the art and are readily accessible by those skilled in the art. Indeed, such database and/or server modules may include those taught in U.S. Pat. Nos. 6,484,165 and 6,321,224; which are incorporated by reference herein for their supportive teachings.

In one embodiment, the location database module 250 is in communication with the tracking module 160 and functions to track and store the location of a plurality of MCDs 120, 130. In the embodiment illustrated in FIG. 2, the tracking module is integrated within the control module. In the embodiment illustrated in FIG. 1, the tracking module is separate from the control module. It is understood that such may be the case for other modules as well. The location of a plurality of MCDs may be tracked on a real-time basis, such that the tracking module 160 is continuously tracking the location and/or position of a plurality of MCDs 120, 130. These locations and/or position are continuously being updated and stored in the location database module 250. When a MCD 120, 130 desires to locate another MCD 120 within a defined radius, the location database module 250 functions to match those MCD users within a defined radius.

FIG. 2 shows the database module 240 further includes a matchmaker database module 260 which is in communication with the user profile modules 140, 150 and the control module 110. The matchmaker database module 260 functions and/or includes instructions for matching up the plurality of user profile modules 140, 150 according to similarities and/or differences in data and/or metadata associated with user profile modules 140, 150, discussed in more detail in the following paragraph.

Referring back to FIG. 1, the system for matching users of MCDs includes: a first user profile module 140 associated with the first MCD 120 and in communication with the control module 110; and a second user profile module 150 associated with the second MCD 130 and in communication with the control module 110. Indeed, there may be a plurality of user profile modules 140, 150 each associated with a particular MCD, and each profile module 140, 150 in communication with the control module 110. The profile modules 140, 150 include data and metadata regarding a variety of attributes associated with the user of a MCD. Some non-limiting examples of attributes include: a user's personality, interests, dreams, goals, hobbies, romantic interests and/or preferences, employment, employment interests, and/or so forth. Additionally, the first user profile module 140 and the second user profile module 150 includes data and/or metadata about the locations and/or positions of the first MCD 120 and the second MCD 130, respectively.

Shown in FIGS. 1 and 2, the system 100 for matching users of MCDs also includes a tracking module 160 in communication with the control module 110 and including instructions for locating the first MCD 120 and the second MCD 130. The tracking module 160 may include a global positioning systems module 220 (GPS) or any other locating device known in the art. The tracking module 160 may exist as a component of the control module 110 or may be a separate module. Additionally, a tracking module is incorporated into the first MCD 120 and the second MCD 130; indeed each MCD in the system 100 includes a tracking module 160. The tracking module 160 may include a transceiver, receiver or other module in the MCD 120, 130 that sends and receive location signals to a centralized source. Such GPS and/or tracking modules may be used and/or include components as taught in U.S. Patent Publication 2006/0217129 and International Patent Publication No. WO2007043752; which are incorporated by reference herein for their supportive teachings.

As shown in FIGS. 1 and 2, the system 100 for matching users of MCDs additionally includes an event module 170 in communication with the control module 110. The event module 170 includes instructions for matching an event to the first user profile module 140 and the second user profile module 150. The event module 170 further includes instructions for comparing a first user record and a second user record to an event location 172, event activity 174, and event time 176. If a match is found then the event module 170 will select an event characteristic from the group consisting of: event location 172, event activity 174, event time 176, and/or any combination thereof. If a match is not found the instructions include making further comparisons 310. The event module 170 further includes instructions for selecting an event characteristic selected from the group consisting of: event location 172, event activity 174, and event time 176. The event module 170 automatically matches event activities 174, event locations 172, and event times 176 that match and/or are similar to the data and/or metadata of first user profile module 140 and the second user profile module 150. Event location 172 may be any location contemplated in the art. Some non-limiting examples include: an address, a building and/or restaurant, theatre, club and/or so forth. Event activity 174 may be any activity contemplated in the art. Some non-limiting examples include: a sporting event, a theatre event, a convention, a business and/or other social gathering, and/or so forth. Event time 176 may include any unit of time contemplated in the art. Some non-limiting examples include: hours and minutes, day, date, and/or so forth.

In another embodiment, the event module 170 may include an event database module in which data associated with a plurality of events, locations, and times are managed and/or stored. The event database module functions and/or includes instructions for assisting the event module in providing data and/or metadata regarding the events, location and/or times. In one non-limiting example, if a first and second MCD are matched with a particular event, the event database module provides information relating to event content, location, and time.

In an alternative embodiment, the event module 170 may include instructions for automatically matching an event time to an MCD user's schedule and/or scheduled tasks. Additionally, the event module 170 may automatically schedule and/or include instructions for incorporating a matched event on a MCD user's scheduling and/or appointment software, such as but not limited to, outlook and/or daily planners.

In yet another embodiment, the system 100 for matching users of MCDs includes instructions for prompting a user to select the event 340. The system 100 may prompt a user to select an event in any manner contemplated in the art. In one non-limiting example, the system 100 displays a list of suggested events on a users' MCD. In another non-limiting example, the system 100 prompts a user to select an event characteristic. The system 100 then displays a list of suggest events according to the selected characteristic on a users' MCD 120, 130.

Shown in FIG. 2, the system 100 for matching users of MCDs also includes a graphical user interface (GUI) module 230 in communication with the control module 110. The GUI module 230 may also be incorporated into or be part of a user MCD 120, 130. Additionally, the GUI module 230 may be part of, incorporated into, and/or be in communication with the control module 110. The GUI module 230 may include any type of GUI contemplated in the art. Some non-limiting examples of GUIs include: a website or other network interface system, a keyboard, audio receiving and/or transmitting module, and/or so forth. The GUI module 230 may further include the screen and/or speakers of any MCD contemplated in the art.

Also shown in FIG. 2, the control module 110 further comprises an audio/video module 270, configured to enable audio/video profiles. The audio/video module 270 may function to enable user profile modules to contain data and/or metadata in an audio and/or video form. In one non-limiting example, the data and/or metadata in a user profile module 140, 150 is audio and/or video file of a MCD user talking about and/or showing his or her attributes, personal interests, and/or so forth. In another non-limiting example the audio and/or video data includes an audio and/or video file talking about and/or showing the location and/or position of a MCD user. Additionally, the audio/video module 270 may be incorporated into and/or be in communication with the first MCD 120 and/or second MCD 130.

In another embodiment, the first MCD 120 is provided selective access to the second profile module 150. The control module 110 may include instructions for enabling the first MCD 120 selective access to the second profile module 150. The control module 110 may also include instructions for selectively communicating to the first MCD 120 data and/or metadata associated with and/or from the second profile module 150. In being selectively communicated, the control module 110 and/or a user profile module 140, 150 may include conditions and/or limitations on data and/or metadata that must be satisfied so that the data and/or metadata may be communicated. In one non-limiting example, data from and/or associated with the second user profile module 150, such as audio and/or video data, may be communicated to a first user MCD 120 once the user of the second MCD 130 communicates his or her consent. The first user MCD 120 may then display the audio and/or video file. Additionally, the system 100 for matching includes the ability to selectively communicate a user profile module 140, 150 to any user MCD 120, 130. The user profile modules 140, 150 selectively communicated to the any user MCD 120, 130 may be view by a user MCD 120, 130 on the GUI module incorporated in the user MCD 120, 130. Advantageously, enabling a user MCD 120, 130 view a audio and/or video user profile module would allow potential MCD users to obtain the a substantial amount of information before deciding to meet and/or communicate with another MCD user.

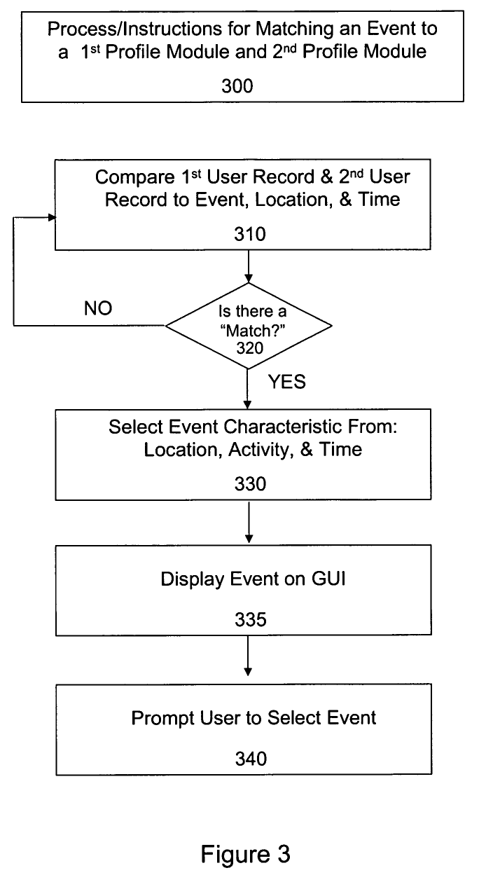

FIG. 3 illustrates a method and/or process for matching 300 an event to a 1^{st} profile module and a 2^{nd} profile module. The process and/or method comprise the steps of: comparing 310 a first user record and a second user record to an event, location, and/or time. The first user record and second user record may be compared 310 with those events, locations, and/or times contained in the event database. Additionally, events, locations, and/or times included in one or more user profile modules 140, 150 may be compared and/or incorporated as part of the event module 170.

As shown in FIG. 3, once the system and method determine 320 there is a match, the system and method enables a user profile to select 330 an event characteristic, including a location, an activity, and/or a time. In a non-limiting example, the selection 330 of the event characteristic may be presented to a user via his or her profile module 140, 150 through the user's MCD 120, 130. Indeed, as described previously, the method may include presenting and/or enabling a user to select 330 the event characteristic from a list of matched event characteristics. The one or more event characteristics may be displayed 335 on the GUI module incorporated as part of a user's MCD. The one or more event characteristics may be displayed in any manner contemplated in the art or as described herein. In one embodiment, instead of or in association with selecting an event characteristic in the case of a match, there may be a transfer or display of additional profile information, or other matching functions based on a user profile. Such user profile may be a profile already utilized or may be a different profile.

Also shown in FIG. 3, the method includes prompting 340 a user to select an event. Prompting 340 a user to select an event may include any features, components and/or module contemplated in the art, or as described herein. Some non-limiting examples include, selection via touch screen panel, voice recognition, pressing appropriate keys on a user's MCD, and/or so forth.

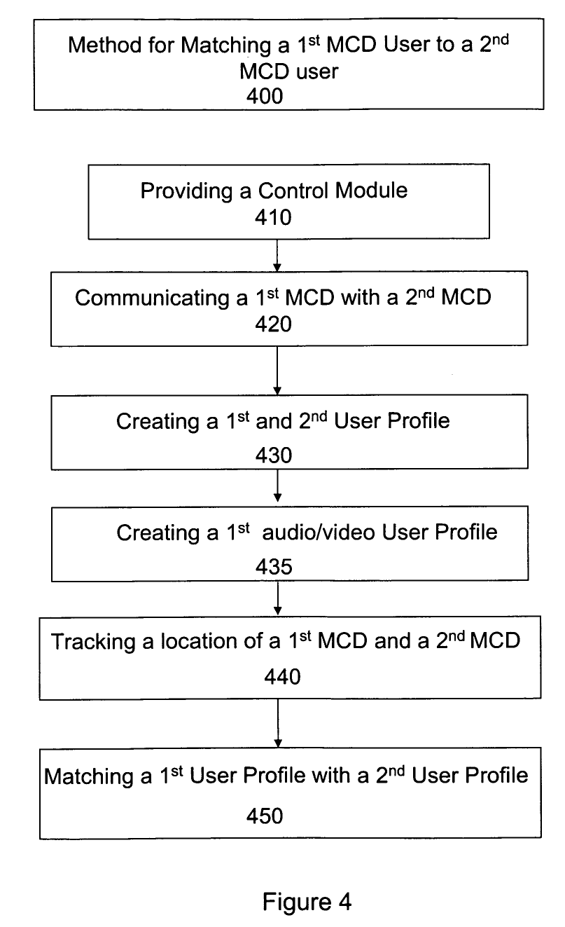

Shown in FIG. 4, there is a method 400 for matching users of MCDs. The method 400 may be executed and/or performed by the system 100 as previously described. The method 400 comprises the steps of: providing 410 a control module; communicating 420 a first MCD with a second MCD; creating 430 a first user profile associated with the first MCD, and in communication with the control module; creating 430 a second user profile associated with the second MCD, and in communication with the control module; tracking 440 a location of each of the first MCD and the second MCD; matching 450 a first user profile with a second user profile. Matching 450 a first user profile with a second user profile 450 includes: comparing 520 a first record associated with the first user profile to a second record associated with the second user profile; communicating 545 the first record to the second MCD upon satisfaction of a first condition; displaying the location of the second MCD on the first MCD upon satisfaction of a second condition 560; and guiding the first MCD to the location of the second MCD upon satisfaction of the second condition 560.

Still looking at FIG. 4, the method for matching users of MCDs includes providing 410 a control module. The control module 110 functions to administer, control, and manage communications between the first MCD 120 and the second MCD 130; indeed the communications between a plurality of MCDs in the system. The control module 110 may exist in any form contemplated in the art. The illustrated control module 110 further includes all of the components and/or functions described in previous paragraphs.

In yet another embodiment, the method 400 for matching users MCDs includes communicating 420 a first MCD with a second MCD. The first MCD 120 and the second MCD 130 may be any type and/or kind of MCD contemplated in the art, or as previously described herein. Further, the method 400 may also include selectively communicating 420 a first MCD with a second MCD. In selectively communicating 420 a first MCD with a second MCD, limitations and/or conditions must be satisfied before the first MCD is placed in communication with, receives, and/or sends communications to the second MCD. The limitations and/or conditions may be put in place and/or selected by the control module 110, the first MCD 120, and/or the second MCD 130. The limitations and/or conditions may be any contemplated in the art, or as previously described herein. Some non-limiting examples of limitations and/or conditions include: consent by a MCD 120, 130 and/or control module 110; activation and/or registration of an MCD 120, 130; a MCD 120, 130 within a predefined location and/or event; and/or so forth.

FIG. 4 illustrates the method 400 includes creating 430 a first user profile and a second user profile. In creating 430 a user profile, a user profile module 140, 150 is created. A user profile module may be created 430 by any means contemplated in the art. In one non-limiting example a user profile module 140, 150 is created when a person registers his or her MCD with the control module 110. A user profile module 140, 150 is created by selecting and/or inputting data and/or metadata associated with user attributes into a user profile module 140, 150. A user profile module 140, 150 may additionally be updated after registration, modifying, adding, and/or deleting data. In one embodiment, data may be inputted via a GUI module 230 incorporated into the control module 110 and/or a user MCD 120, 130. Additionally, a user profile module 140, 150 may be created at a website via a network.

In another embodiment, as illustrated in FIG. 4, creating 430 the first user profile includes creating 435 an audio and/or video profile. The audio and/or video profile may include data and/or metadata regarding the attributes and preferences described herein.

In yet another embodiment, data and/or metadata associated with a user profile module 140, 150 may include one or more attributes, user preferences, locations and/or positions of a user MCD, and/or so forth. The user profile module 140, 150 may further include a frequency ID and/or tracking number with which the tracking module 160 may locate and/or pinpoint the location of a particular MCD associated with a particular user profile module. Some non-limiting examples of attributes may include:

Personality type attributes may include: optimist, pessimist, introvert, extrovert, personality color. Additionally, personality attributes may include a sliding scale from 1-10 of what degree a user is an optimist, introvert, personality color, etc. Color attributes are further described and found in U.S. Pat. No. 6,549,213, which is incorporated by reference herein for its supportive teachings. Additionally, a personal attribute may include those attributes of a famous person to which a user may match himself or herself. Attributes may additionally include:

Religious attributes: denomination and/or church, beliefs, practices, and/or so forth.

Interests and/or hobby attributes: work interests, spare time, hobbies, where a user spends his or her spare time, future interest, clubs and/or other social gatherings events. Interests and/or hobbies may include specific categories such as: sports, arts, music categories, education, foods, pastimes, vehicles, movies, and/or so forth.

Romantic and/or relationship attributes: physical attributes (such as height, age, etc), sexual interests & preferences, gender, type of relationship(s), age, location, frequency, communication style, religion/spirituality, shared interests/activities, education level, and/or so forth.

Dreams and/or goals attributes: Specific experiences and achievements sought, individual vs. shared, assistance/partners sought, resources needed, challenges, and/or so forth.

Additionally, attributes associated with political views, educational institutions, occupation, heritage, hometowns, problems and/or illness may also be included in user profile module 140, 150.

As shown in FIG. 4, the method 400 for matching users of MCDs further includes tracking 440 a location of each the first MCD and the second MCD. Tracking 440 the location of the first MCD and the second MCD 440 be accomplished in any manner contemplated in the art, or as previously described herein. In one non-limiting example, the tracking module 160 is used to locate and/or pinpoint the location of the first MCD 120 and the second MCD. Indeed, the method 400 may include tracking 440 a plurality of MCDs 120, 130 registered with the control module 110.

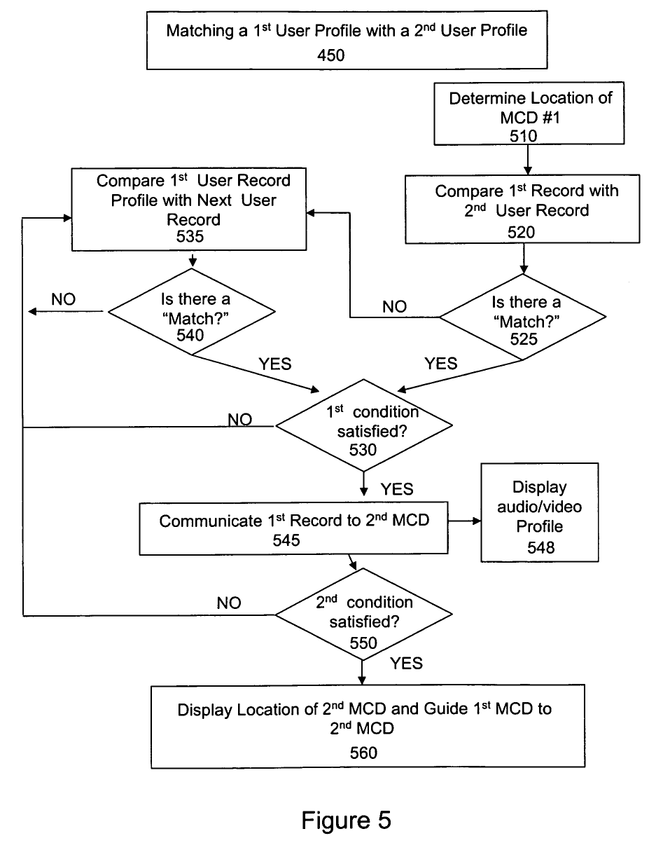

As demonstrated by FIG. 5, the method for matching users of MCDs 400 further includes matching 450 the first user profile with a second user profile. The matching 450 includes: Determining 510 the location of the first MCD. Determining 510 the location may be accomplished in any manner contemplated in the art, or as described herein. Matching 450 users of MCDs further includes comparing 520 a first record associated with a first user profile to a second record associated with a second user profile. Comparing 520 the first record to the second record may be accomplished in any manner contemplated in the art. In one non-limiting example, the database module 240, as described previously, functions to compare data in the first record to data in the second record. Indeed, the first user profile and first record, and second user profile and second record, may be included as part of and/or incorporated into the first user profile module 140 the second user profile module 150, respectively, and as described previously herein. The first record and second record may further include any or all of the attributes, preferences, data, and/or metadata included as part of the first user profile module 140 and second user profile module 150, respectively, and as described previously herein.

As illustrated in FIG. 5, if it is determined 525 there is not a match then the first user record is compared 535 with a subsequent or next user record, and so on and so forth until a matching user record is located. Upon matching the first record with a second or subsequent user record the method then decides 530 if the first condition is satisfied. The first condition may include any condition and/or limitation contemplated in art, or as described previously herein. In one non-limiting example, the first condition includes instructions and/or a communication from control module 110 and/or the second MCD 130 consenting to receiving data from the first record. In another non-limiting example, a second MCD 130 receives a communication from the control module and/or the first MCD indicating the first MCD 120 desire to send data. If the user associated with the second MCD 130 desires to receive communications and/or information regarding the first MCD and/or other MCDs, the second user sends a communication to the control module 110 and/or demonstrates his or her desire, thus satisfying the first condition.

As shown in FIG. 5, upon satisfaction the first condition the method includes communicating 545 the first record to the second MCD. Communicating 545 the first record to the second MCD may include any features, data, and/or metadata included in the first record as contemplated in the art, or as described herein. In a non-limiting example, communicating 545 the first record to the second MCD includes displaying 548 the audio and/or video profile of the first record, or the data associated with the first user profile.

Also, as shown in FIG. 5, the method 400 includes displaying 560 the location of the second MCD upon satisfaction 550 of a second condition. The second condition may include affirmation, verification and/or confirmation of a positive desire to meet and/or have the system display 560 locations and/or event information. The second condition may be satisfied in any manner contemplated in the art, or as described previously herein. In one non-limiting example, the second condition includes instructions and/or a communication from the control module 110 and/or the second MCD 130 consenting to the communication and/or display of the second MCD's 130 location. Communicating the second user's desire may be accomplished in any manner contemplated in the art, or as described herein, such as but not limited to via touch panel, key, or voice recognition on the second MCD device.

As shown in FIG. 5, the method includes displaying 560 the location of the second MCD upon satisfaction 550 of a second condition. Displaying the location of the second MCD 130 may be accomplished in any manner contemplated in the art. In one non-limiting example, GPS coordinates are displayed on the GUI module of a MCD 120, 130. In another non-limiting examples, a street address, location address, and/or location name is displayed.

Additionally, as shown in FIG. 5, the method 400 includes guiding the first MCD to the location of the second MCD upon satisfaction of the second condition 550, 560. Guiding the first MCD 120 to the second MCD 130 may be accomplished in any manner contemplated in the art. In one non-limiting example, the pictures of the location of the second MCD 130 may be displayed on the first MCD 120. Additionally, audio and/or video assistance may be communicated to the first MCD 120. The audio assistance may include a voice directing the first MCD 120, supplying direction and/or distance instructions. Additionally, a graphical map may be provided showing the real time positions of the first MCD 120 and the second MCD 130. Guiding the first MCD to the location of the second MCD 560 may be accomplished through the use of the tracking module, previously described herein.

In still another embodiment, there is an article of manufacture comprising a program storage medium readable by a processor and embodying one or more instructions executable by the processor to perform a method 400 for matching users of mobile communication devices. The method 400 comprises the steps of: providing 410 a control module; communicating 420 a first mobile communication device with a second mobile communication device, each of the first mobile communication device and the second mobile communication device in communication with the control module; creating 430 a first user profile associated with the first mobile communication device, and in communication with the control module; creating 430 a second user profile associated with the second mobile communication device, and in communication with the control module; tracking 440 the location of each of the first mobile communication device and the second mobile communication device; matching 450 a first user profile with a second user profile, wherein the matching includes: comparing 520 a first record associated with the first user profile to a second record associated with the second user profile; communicating 530, 545 the first record to the second communication device upon satisfaction of a first condition; displaying 550, 560 the location of the second communication device on the first communication device upon satisfaction of a second condition; and guiding 550, 560 the first communication device to the second communication device upon satisfaction of the second condition. The above described method may be a carried out in any manner contemplated in the art, or as previously described herein.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the specification describes a first MCD 120 and a second MCD 130, the system and method for matching users of MCDs 100, 400 may include a plurality of MCDs and/or users of MCDs able to be matched with and/or in communication with other MCDs and/or the control modules.

It is also envisioned that the control module 110 may be incorporated into each of the MCDs 120, 130, thereby likely eliminating the need for a central control module 110, and therefore, likely enabling MCDs to communicating and/or matching directly.

Finally, it is envisioned that the components of the device may be constructed of a variety of materials. Some non-limiting examples of these materials include: software, hardware, circuits, communication devices and/or systems, computer processors, storage drives, servers, LCD and/or other types of displays and/or GUIs, GPS satellite navigations systems, and/or so forth.

The following are exemplary and prophetic embodiments of the invention in a narrative form:

Dating.

Jane and Bob are single people and desire to expand their network of dating possibilities. They prefer to explore people they can meet in person right away rather than go through a web-based (delayed) system of matching.

Each creates a personal profile that an expert wizard prompts for ease of entry. Information includes standard data such as physical description, education level, age, interests, and any keywords that describe a person. They then fill out one or more “matching profiles” for someone whom they'd be interested in dating.

There are also “layered profiles.” For instance, a woman might not put certain identifying information about herself and her “public profile”, in order to prevent men from pretending to share interests (such as, for example, tennis) in order to be more appealing to her. Instead, she would reserve such more personal and perhaps intimate information for a deeper profile after she had established that she wished to get to know someone.

Each person can set the system to operate within a certain physical radius that they get to specify. (If the number of hits is too great, they can shorten the radius, and if it's too small they can widen the radius.) The search can be continuous, or they can set up tort only during certain times of day or even in certain places, for example, on a trip.

Let's say that Jane and Bob have both set up profiles that describe themselves, as well as profiles that describe what they're seeking in a romantic companion. When one of them comes within the other's designated search radius during a time that the system is in active search mode, the system gives a notification when searching persons cell phone. Let's say that Jane's search radius is wider than Bob's. Bob pops up on her screen.

The notification may take the form of a flashing dot on the screen. A dot offering a better match than other dots may be brighter, or it may have a system of stars associated with it perhaps varying from one star to five stars. (A single point of match between two people would be designated by a single star, and the system would go all the way up to five stars for five or more points of matching.)

Jane can move the cursor over the dot, and Bob's “public profile”—really, just a brief few paragraphs of introduction in most cases—will pop up on her screen along with a photograph or two. They may also offer a short audio video introduction of himself which you can select to watch.

If she likes what she sees, she “nametags” Bob. Bob receives a notification on his cell phone telling them he's been “nametagged.”

He has access to reciprocal information about Jane. The two can then exchange whatever information they wish: deeper profiles, e-mail addresses, or cell phone number so they can immediately speak on the phone. In many cases, they may be sufficiently close to each other that they can actually see each other in the distance, and the phones can bring them together. (This could be a kind of fun game for strangers to play together.)

Further, if they decide they want to spend some time getting acquainted, the system can use the GUS feature to guide them to the nearest coffee shops or other facilities where they can share a cup of coffee or otherwise sit down and get acquainted. Further, such facilities may be wired into the system such that they offer special coupons such as dollar off a cup of coffee to encourage people to visit them.

It is envisioned that there may be “hotspots” that may be designated facilities in specific geographic areas and encourage users to frequent them, especially at particular times or circumstances (parties, promotional events) might be branded. Obviously, a greater density of users relative to nonusers increases the potential utility of the service.

Business Networking

This can work in exactly the same manner as social networking, with additional potential uses.

For example, people who attend a specific kind of seminar or other business networking event may find that they can tailor their search functions much more precisely since they were screened a lot of the “noise”.

Further, a system developer may partner with such business events to facilitate people meeting in exchanging information. This can change the current mode of connection which tends to be haphazard and efficient into something very efficient.

Suppose for example, revisiting Jane and Bob, that Jane seeks investor for her new retail establishment. She needs $50,000. Bob is an investor with interest in retail, among other things. He is open to investing in the range of 25,000 to $100,000. On this basis, a system could match the two of them together.

Planned Gatherings

Those planning social events may need to coordinate multiple schedules or risk non-participation. With respect to formal events, planners expend considerable effort. An embodiment of the invention would streamline the process.

With respect to informal events such as getting a group of friends together for a movie or dinner party, the amount of work involved is often so daunting that people simply make a halfhearted effort or give up the attempt. Social events abort in the making.

With an embodiment of the invention, the process is streamlined.

People “opt in” to share certain kinds of activities with others, or may simply designate others as “friends.” When someone wishes to organize a group to attend, for example, a movie here's how it can work.

The organizer sends out a notice via the system asking who would like to attend a theater showing of the latest hit movie. Those responding give the system access to their schedules, and it tells the organizer who can attend which showings. (It may display the results in clusters; showing that out of ten friends, seven can attend only one specific showing, while two groups of five can attend two other possible showings.)

In another configuration, the system may ask people you should see the movie to designate the dates and times they are available. (This may be helpful if the person in question did not have a scheduler program that can interface with the system.)

The entire event ordination process becomes a relatively painless and quick one, allowing for far more such gatherings in the form of movies, dinner parties and other social events.

Impromptu Gatherings

In this case, using a friends monitoring function similar to what Helios and other systems are offering whereby a user contract locations of friends, the system will notify someone when a friend comes within a certain radius.

Here's an example of a potential use. A man is having lunch downtown. Unknown to him, his wife does some shopping in a store just a block away. She does not know about his lunch. Without the system, each is oblivious to the possibility of a delightful spontaneous encounter.

He decides to purchase a flower, card or some other romantic gift and surprise her with it.

He uses the system to identify a suitable store nearby, quickly arranges the purchase while tracking her movements (having previously obtained such permission) to make sure he doesn't lose her, and then surprises her with the gift.

Monitoring

One exception to an opt-in permission-based monitoring would be children. The system could be used to track the whereabouts of one's children or whereabouts of other's children with express permission (given by parents via the system and recorded in the system.) Friends and relatives might use this to track children on trips, as might teachers and other designated supervisors.

The system could also be used to track elderly relatives who may need special monitoring and care, though in this case permission would either be granted by the relative or by a controlling legal authority.

It is also contemplated that the embodiments of the invention may consist of or consist essentially of one or more of the functions, features, structures, and/or modules described herein, and that such functions, features, structures, and/or modules may consist of or consist essentially of one or more of the functions, features, structures, and/or modules described herein.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system for matching users of mobile communication devices, comprising:
a control module;
a first mobile communication device in communication with the control module;
a second mobile communication device in communication with the control module;
a first profile module associated with the first mobile communication device and in communication with the control module;
a second profile module associated with the second mobile communication device and in communication with the control module;
a tracking module in communication with the control module, and including instructions for tracking the location of the first mobile communication device and the second mobile communication device; and
an event module in communication with the control module, and including instructions for performing the steps of:
matching an event to the first profile module and the second profile module; and
selecting an event characteristic selected from the group consisting of: event location, event activity, and event time; or any combination thereof.

2. The system of claim 1, wherein the event module includes instructions for prompting a user to select the event.

3. The system of claim 1, further comprising a graphical user interface module in communication with the control module.

4. The system of claim 1, further comprising an audio/video module in communication with the control module, configured to enable audio/video data and wherein the second mobile communication device is in selective communication with the first mobile communication device.

5. The system of claim 4, wherein the first mobile communication device is provided selective access to the second profile module.

6. The system of claim 5, wherein the selective access comprises an audio/video profile associated with the second profile module.

7. The system of claim 5, wherein the audio/video profile is displayed on the graphical user interface display module.

8. The system of claim 1, wherein the tracking module comprises a global positioning module.

9. A method for matching users of mobile communication devices, comprising the steps of:
providing a control module;
communicating a first mobile communication device with a second mobile communication device;
creating a first user profile associated with the first mobile communication device, and in communication with the control module;
creating a second user profile associated with the second mobile communication device, and in communication with the control module;
tracking a location of each of the first mobile communication device and the second mobile communication device;
matching a first user profile with a second user profile, wherein the matching includes:
comparing a first record associated with the first user profile to a second record associated with the second user profile;
communicating the first record to the second mobile communication device upon satisfaction of a first condition;
displaying the location of the second communication device on the first communication device upon satisfaction of a second condition; and
guiding the first mobile communication device to the location of the second mobile communication device upon satisfaction of the second condition.

10. The method of claim 9, wherein selectively guiding the second communication device to the location of the first communication device further comprises audio and video assistance.

11. The method of claim 9, further comprising the steps of:
matching an event to the first user profile and a second user profile; and
selecting an event characteristic from the group consisting of: event location, event activity, and event time; or any combination thereof.

12. The method of claim 9, further comprising prompting a user to select the event characteristic.

13. The method of claim 9, further comprising displaying the event on a graphical user interface module.

14. The method of claim 9, wherein creating the first user profile comprises creating a first audio/video profile.

15. The method of claim 14, further comprising communicating the first audio/video user profile to the second mobile communication device upon occurrence of a first condition.

16. The method of claim 15, further comprising displaying the first audio/video profile, on a graphical user interface module.

17. An article of manufacture comprising a program storage medium readable by a processor and embodying one or more instructions executable by the processor to perform a method for matching users of mobile communication devices, the method comprising the steps of:
providing a control module;
communicating a first mobile communication device with a second mobile communication device, each of the first mobile communication device and the second mobile communication device in communication with the control module;
creating a first user profile associated with the first mobile communication device, and in communication with the control module;
creating a second user profile associated with the second mobile communication device, and in communication with the control module;
tracking the location of each of the first mobile communication device and the second mobile communication device;
matching a first user profile with a second user profile, wherein the matching includes:
comparing a first record associated with the first user profile to a second record associated with the second user profile;
communicating the first record to the second communication device upon satisfaction of a first condition;
displaying the location of the second communication device on the first communication device upon satisfaction of a second condition; and
guiding the first communication device to the second communication device upon satisfaction of the second condition.

18. The article of manufacture of claim 17, further comprising the steps of:
matching an event to the first user profile and the second user profile; and
selecting an event characteristic from the group consisting of: event location, event activity, and event time.

19. The article of manufacture of claim 15, further comprising prompting a user to select the event characteristic.

20. The article of manufacture of claim 15, further comprising displaying the event on graphical user interface display module.
